(19) United States
(12) Patent Application Publication
(10) Pub. No.: US 2014/0016055 A1
(43) Pub. Date: Jan. 16, 2014

(54) ARRAY SUBSTRATE AND LIQUID CRYSTAL PANEL WITH THE SAME

(71) Applicant: Liang Xu, Shenzhen (CN)

(72) Inventor: Liang Xu, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/641,130

(22) PCT Filed: Jul. 17, 2012
(86) PCT No.: PCT/CN2012/078741

§ 371 Date: Oct. 15, 2012

(30) Foreign Application Priority Data
Jul. 10, 2012 (CN) 201210237359.1

(51) Int. Cl. G02F 1/1362

(52) U.S. Cl. CPC G02F 1/136286
USPC 349/43

(57) ABSTRACT

An array substrate includes a substrate, a number of parallel data lines disposed on the substrate each which has a first end and a second end, a signal inputting module for inputting an alignment signal; and at least one transmitting line with one end thereof connected to the signal inputting module and the at least one transmitting line being further connected to the first end and the second end of each of the data lines. When there is an open defect in one of the data lines, the alignment signal is capable of being transmitted to the corresponding data line from the first end and the second end thereof through the transmitting line, which allows the alignment signal to be applied to the corresponding data line except the open defect. This improves the alignment consistence of liquid crystal molecules and reduces the scrap rate of the liquid crystal panel.

### BACKGROUND

1. Technical Field

The present disclosure relates to liquid crystal displaying technologies and, particularly, to an alignment wiring structure of an array substrate and a liquid crystal panel with the same.

2. Description of Related Art

With the development of electronic technology, panel displays such as liquid crystal displays, plasma displays, and organic light-emitting diode displays have gained rapid development. Compared to other types of display, the LCD is thin and it requires lower driving voltage and lower power consumption, making it increasingly replace the display with cold cathode fluorescent lamps. PSVA (polymer stabilize vertical alignment) technology is commonly used in LCDs.

In a PSVA type LCD, reactive monomers are added to negative liquid crystal material. After the liquid crystal cell is formed, a voltage is applied to two ends of the liquid crystal cell to allow the monomers to react while being irradiated with ultraviolet light to finish liquid crystal photoalignment.

Referring to FIG. 1, which is a schematic view of a voltage applying circuit of the present PSVA type liquid crystal panel. The liquid crystal panel includes a number of data lines 10. The voltage applying circuit includes a signal input module 20 and a transmitting line 30. A first end 10a of each of the data lines 10 is connected to the transmitting line 30. However, in the process of forming the data lines 10, there may be open defect in the data lines 10 due to various factors. As shown in FIG. 1, if one of data lines 10 is open at a point D, an electrical signal transmitted to the corresponding data line 10 via the transmitting line 30 is prevented from being further transmitted to the other part of the corresponding line when reaching the point D. This results in the abnormal alignment of the liquid crystal molecules and further results in the defect of the liquid crystal panel, which reduces the yield rate of the liquid crystal panel.

### SUMMARY

The present disclosure provides an array substrate. The array substrate includes a substrate, a number of parallel data lines disposed on the substrate each which has a first end and a second end, a signal inputting module for inputting an alignment signal, and at least one transmitting line with one end thereof connected to the signal inputting module. The at least one transmitting line is further connected to the first end and the second end of each of the data lines.

Preferably, the signal inputting module is disposed on the substrate and is adjacent to the first end of each of the data lines; the at least one transmitting line is connected to the signal inputting module and extends from one side of the substrate adjacent to the first end of each of the data lines to the other side of the substrate adjacent to the second end of each of the data lines.

Preferably, the at least one transmitting line includes a first transmitting line and a second transmitting line, the data lines on the substrate form a number of data units each which includes a first data line and a second data line, a first end and a second end of the first data line are connected to the first transmitting line, and a first end and a second end of the second data line are connected to the second transmitting line.

Preferably, the at least one transmitting line includes a first transmitting line, a second transmitting line, and a third transmitting line; the data lines form a number of data units each which includes a first data line, a second data line, and a third data line, a first end and a second end of the first data line are connected to the first transmitting line, a first end and a second end of the second data line are connected to the second transmitting line, and a first end and a second end of the third data line are connected to the third transmitting line.

Preferably, the signal inputting module includes a main inputting unit and a synchronous inputting unit for synchronously inputting the alignment signal with the main inputting unit, the at least one transmitting line includes a main transmitting line and a synchronous transmitting line; the main inputting unit and the main transmitting line are disposed one side of the substrate adjacent to the first end of each of the data lines, one end of the main transmitting line is connected to the main inputting unit and the main transmitting line is further connected to the first end of each of the data lines; the synchronous inputting unit and the synchronous transmitting line are disposed on the other side of the substrate adjacent to the second end of each of the data lines; one end of the synchronous transmitting line is connected to the synchronous inputting unit, and the synchronous transmitting line is further connected to the second end of each of the data lines.

Preferably, the main transmitting line includes a first main transmitting line and a second main transmitting line, the synchronous transmitting line includes a first synchronous transmitting line and a second synchronous transmitting line, the data lines form a number of data units each which includes a first data line and a second data line; a first end and a second end of the first data line are respectively connected to the first main transmitting line and the first synchronous transmitting line; and a first end and a second end of the second data line are respectively connected to the second main transmitting line and the second synchronous transmitting line.

Preferably, the main transmitting line includes a first main transmitting line, a second main transmitting line, and a third main transmitting line; the synchronous transmitting line includes a first synchronous transmitting line, a second synchronous transmitting line, and a third synchronous transmitting line; the data lines form a number of data units each which includes a first data line, a second data line, and a third data line; a first end and a second end of the first data line are respectively connected to the first main transmitting line and the first synchronous transmitting line; a first end and a second end of the second data line are respectively connected to the second main transmitting line and the second synchronous transmitting line; and a first end and a second end of the third data line are respectively connected to the third main transmitting line and the third synchronous transmitting line.

Preferably, the array substrate further includes a number of parallel gate lines disposed on the substrate, a driving module for inputting a driving signal, a first conveying line, and a second conveying line; each of the gate lines includes a first terminal and a second terminal; the first conveying line is connected to the first terminal of each of the gate lines and the driving module, and the second conveying line is connected to the second terminal of each of the gate lines.

Preferably, the array substrate further includes a synchronous driving module for synchronously inputting the driving signal with the driving module, the synchronous driving module is connected to the second conveying line.

Preferably, the alignment signal is transmitted to each of the data lines from the first end and the second end of the corresponding data line through the at least one transmitting line.

The present disclosure further provides a liquid crystal panel. The liquid crystal panel includes a color filter substrate, an array substrate, and liquid crystal molecules disposed between the array substrate and the color filter substrate. The array substrate includes a substrate, a number of parallel data lines disposed on the substrate each which has a first end and a second end, a signal inputting module for inputting an alignment signal, and at least one transmitting line with one end thereof connected to the signal inputting module. The at least one transmitting line is further connected to the first end and the second end of each of the data lines.

Preferably, the signal inputting module is disposed on the substrate and is adjacent to the first end of each of the data lines; and the at least one transmitting line is connected to the signal inputting module and extends from one side of the substrate adjacent to the first end of each of the data lines to the other side of the substrate adjacent to the second end of each of the data lines.

Preferably, the at least one transmitting line includes a first transmitting line and a second transmitting line, the data lines form a number of data units each which includes a first data line and a second data line, a first end and a second end of the first data line are connected to the first transmitting line, and a first end and a second end of the second data line are connected to the second transmitting line.

Preferably, the at least one transmitting line includes a first transmitting line, a second transmitting line, and a third transmitting line, the data lines form a number of data units each which includes a first data line, a second data line, and a third data line, a first end and a second end of the first data line are connected to the first transmitting line, a first end and a second end of the second data line are connected to the second transmitting line, and a first end and a second end of the third data line are connected to the third transmitting line.

Preferably, the signal inputting module includes a main inputting unit and a synchronous inputting unit for synchronously inputting the alignment signal with the main inputting unit; the transmitting line includes a main transmitting line and a synchronous transmitting line; the main inputting unit and the main transmitting line are disposed one side of the substrate adjacent to the first end of each of the data lines; one end of the main transmitting line is connected to the main inputting unit and the main transmitting line is further connected to the data lines; the synchronous inputting unit and the synchronous transmitting line are disposed on the other side of the substrate adjacent to the second end of each of the data lines; one end of the synchronous transmitting line is connected to the synchronous inputting unit, and the synchronous transmitting line is further connected to the second end of each of the data lines.

Preferably, the main transmitting line includes a first main transmitting line and a second main transmitting line, the synchronous transmitting line includes a first synchronous transmitting line and a second synchronous transmitting line, the data lines form a number of data units each which includes a first data line and a second data line; a first end and a second end of the first data line are respectively connected to the first main transmitting line and the first synchronous transmitting line; a first end and a second end of the second data line are respectively connected to the second main transmitting line and the second synchronous transmitting line.

Preferably, the main transmitting line includes a first main transmitting line, a second main transmitting line, and a third transmitting line; the synchronous transmitting line includes a first synchronous transmitting line, a second synchronous transmitting line, and a third synchronous transmitting line; the data lines form a number of data units each which includes a first data line, a second data line, and a third data line; a first end and a second end of the first data line are respectively connected to the first main transmitting line and the first synchronous transmitting line; a first end and a second end of the second data line are respectively connected to the second main transmitting line and the second synchronous transmitting line; and a first end and a second end of the third data line are respectively connected to the third main transmitting line and the third synchronous transmitting line.

Preferably, the liquid crystal panel further includes a number of parallel gate lines disposed on the substrate, a driving module for inputting a driving signal, a first conveying line, and a second conveying line; each of the gate lines includes a first terminal and a second terminal; the first conveying line is connected to the first terminal of each of the gate lines and the driving module, and the second conveying line is connected to the second terminal of each of the gate lines.

Preferably, the liquid crystal panel further includes a synchronous driving module for synchronously inputting the driving signal with the driving module, the synchronous driving module is connected to the second conveying line.

Preferably, the alignment signal is transmitted to each of the data lines from the first end and the second end of the corresponding data line through the at least one transmitting line.

With the transmitting line being connected to the signal inputting module and two ends of each of the data lines, the alignment signal can be transmitted to the data line from the first end and the second end of the corresponding data line through the transmitting line, which allows the alignment signal to be applied to the corresponding data line except the cutting point. This improves the alignment consistence of liquid crystal molecules and reduces the scrap rate of the liquid crystal panel.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a present array substrate;

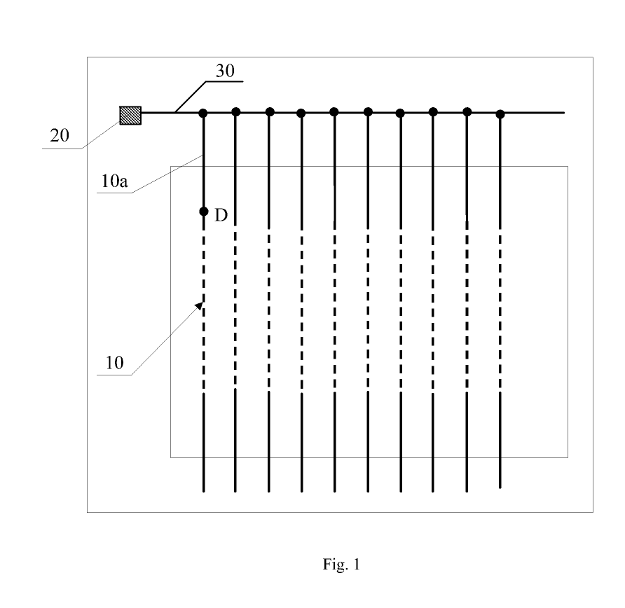

FIG. 2 is a schematic view of an array substrate in accordance with a first embodiment of the present disclosure;

FIG. 3 is a schematic view of array substrate in accordance with a second embodiment of the present disclosure;

FIG. 4 is a schematic view of array substrate in accordance with a third embodiment of the present disclosure;

FIG. 5 is a schematic view of array substrate in accordance with a fourth embodiment of the present disclosure;

FIG. 6 is a schematic view of array substrate in accordance with a fifth embodiment of the present disclosure;

FIG. 7 is a schematic view of array substrate in accordance with a sixth embodiment of the present disclosure;

FIG. 8 is a schematic view of array substrate in accordance with a seventh embodiment of the present disclosure;

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

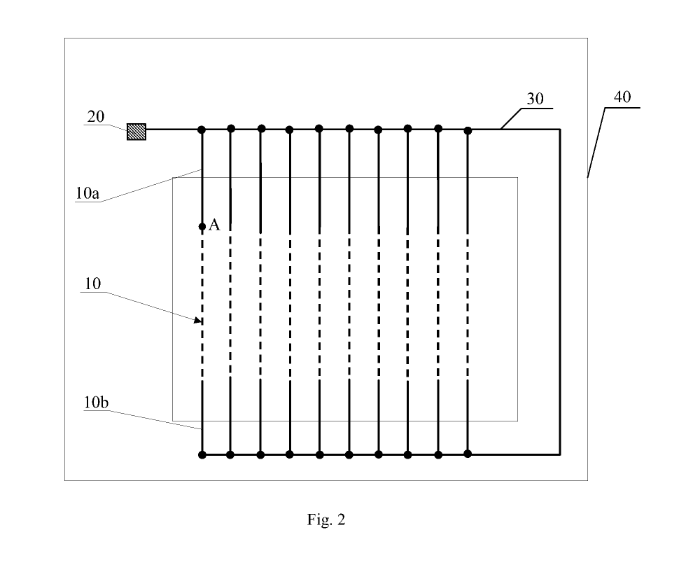

Referring to FIG. 2, an array substrate in accordance with a first embodiment, is shown. The array substrate includes a substrate 40, a number of parallel data lines 10 disposed on the substrate 40, a signal inputting module 20 for inputting an alignment signal, and at least one transmitting line 30. Each of the data lines 10 includes a first end 10a and a second end 10b opposite to the first end 10a. One end of the transmitting line 30 is connected to the signal inputting module 20. The transmitting line 30 is further connected to the first end 10a and the second end 10b of each of the data lines 10. After transmitting through the signal inputting module 20 and the transmitting line 30, the alignment signal is transmitted to each data line 10 through the first end 10a and the second end 10b of the corresponding data line 10.

In the embodiment, the signal inputting module 20 outputs the same alignment signal to the first end 10a and the second end 10b of the same data line 10 through the transmitting line 30. In the alignment process, the alignment signal is transmitted from the signal inputting module 20 to the corresponding data line 10 through the transmitting line 30. In this state, although the data line 10 is open at a point A, the alignment signal is transmitted to the point A through the first end 10a of the corresponding data line 10 and is capable of being applied to the part of the corresponding data line 10 located between the first end 10a thereof and the point A. Meanwhile, the alignment signal is also transmitted from the second end 10b to the point A and is capable of being applied to the part of the corresponding data line 10 located between the second end 10b thereof and the point A. Therefore, the alignment signal can be applied to the whole corresponding data line 10 except the point A to allow the corresponding liquid crystal molecules to be aligned.

The transmitting line 30 is connected to both ends of each of the data lines 10, thus, the alignment signal can be transmitted to the point A through both ends of the corresponding data line 10, which allows the alignment signal to be applied to the whole data line 10 except the point A. This improves the alignment consistence of the liquid crystal molecules and further improves the display effect of the LCD and thus reduces the scrap rate of the liquid crystal panel.

Specifically, the signal inputting module 20 is disposed on the substrate 40 and adjacent to the first ends 10a of the data lines 10. One end of the transmitting line 30 is connected to the signal inputting module 20. The transmitting line 30 extends from one side of the substrate 40 which is adjacent to the first ends 10a of the data lines 10 to the other side of the substrate which is adjacent to the second ends 10b of the data lines 10. The transmitting line 30 is further connected to the second end 10b of each of the data lines 10.

In the embodiment, with the transmitting line 30 being connected to the first end 10a and the second end 10b of each of the data lines 10, the alignment signal is simultaneously transmitted to the first end 10a and the second end 10b of each of the data lines 10. Therefore, when there is an open defect in the corresponding data line 10, the alignment signal can be transmitted to the part of the corresponding data line 10 located between the first end 10a and the open defect through the first end 10a thereof; meanwhile, the alignment signal also can be transmitted to the part of corresponding data line 10 located between the second end 10b and the open defect through the second end 10b thereof. Thus, liquid crystal molecules corresponding to the data line 10 can be aligned normally to reduce the scarp rate of the liquid crystal panel.

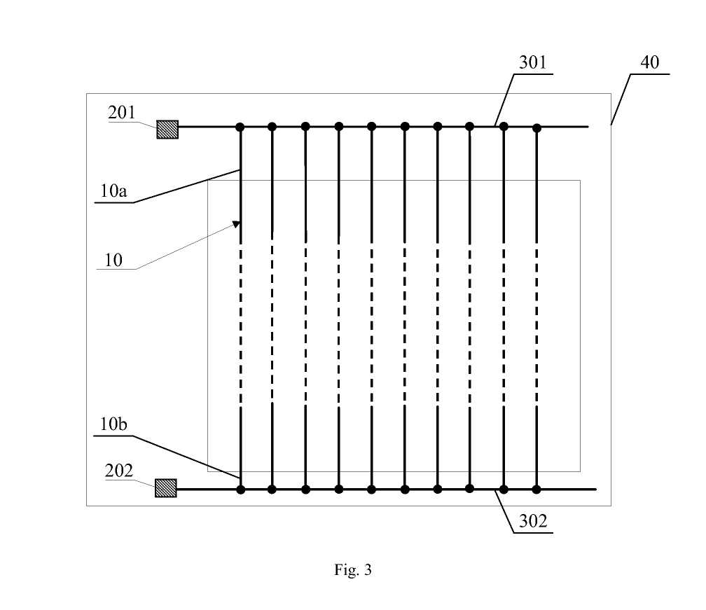

Referring to FIG. 3, an array substrate in accordance with a second embodiment, is shown. The array substrate of the second embodiment is similar to that of the first embodiment, and the differences therebetween lies in: the signal inputting module of the array substrate of the second embodiment includes a main inputting unit 201 and a synchronous inputting module 202, and the transmitting line of the array substrate of the second embodiment includes a main transmitting line 301 and a synchronous transmitting line 302. The main inputting unit 201 and the main transmitting line 301 are disposed on the substrate 40 and are located adjacent to the first end 10a of each of the data lines 10. One end of the main transmitting line 301 is connected to the main inputting unit 201. The main transmitting line 301 is further connected to the first end 10a of each of the data lines 10. The synchronous inputting unit 202 and the synchronous transmitting line 302 are also disposed on the substrate 40 and are located adjacent to the second end 10b of each of the data lines 10. One end of the synchronous transmitting line 302 is connected to the synchronous inputting unit 202. The synchronous transmitting line 302 is further connected to the second end 10b of each of the data lines 10.

When there is an open defect in the data line 10, the alignment signal is transmitted from the main inputting module 201 to the open defect through the main transmitting line 301 and the first end 10a of the corresponding data line 10. Meanwhile, the alignment signal is also transmitted from the synchronous inputting unit 202 to the open defect through the synchronous transmitting line 302 and the second end 10b of the corresponding data line 10. Therefore, the liquid crystal molecules corresponding to the whole data line 10 can be aligned abnormally to reduce the scarp rate of the liquid crystal panel.

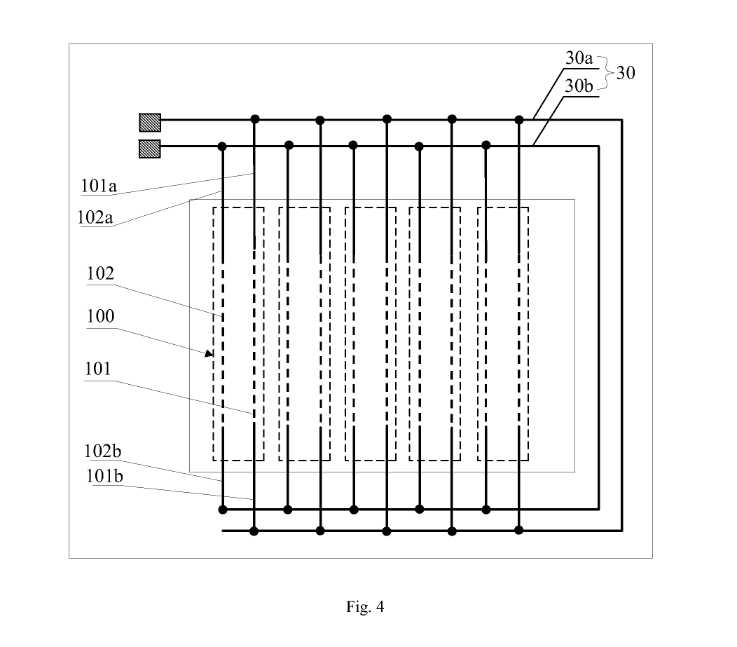

Referring to FIG. 4, an array substrate in accordance with a third embodiment, is schematically shown. Based on the above embodiments, the array substrate of the third embodiment includes two of the transmitting lines. Specifically, the transmitting line 30 of the array substrate of the third embodiment includes a first transmitting line 30a and a second transmitting line 30b. The parallel data lines disposed on the substrate 40 form a number of data units 100. Each data unit 100 includes a first data line 101 and a second data line 102. The first end 101a and the second end 101b of the first data line 101 are connected to the first transmitting line 30a, and the first end 102a and the second end 102b of the second data line 102 are connected to the second transmitting line 30b. The transmitting process of the alignment signal of the array substrate of the third embodiment is similar to that of the above-mentioned embodiments, which is not given in detail here. Since the alignment signal in the embodiment also can be transmitted to the from two ends of the first data line 101 or the second data line 102 to the middle portion of the corresponding data line, the alignment consistence of the liquid crystal molecules and further the display effect of the liquid crystal panel can be improved.

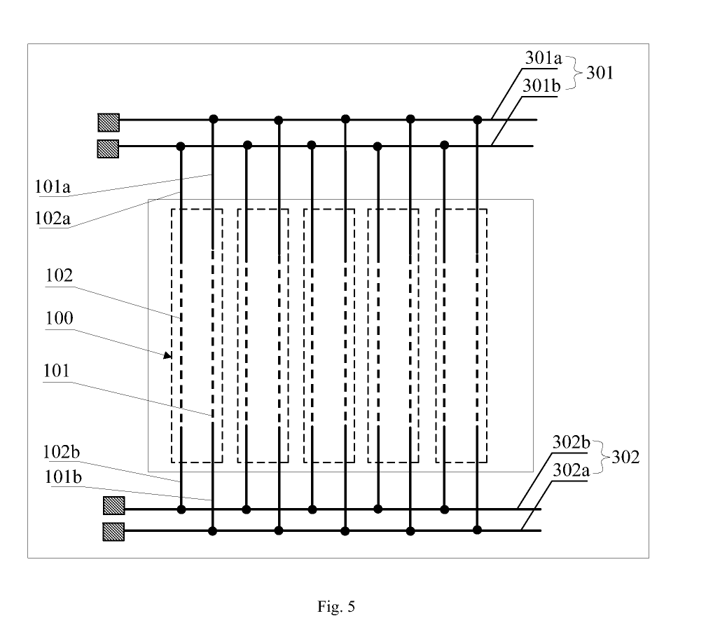

Referring to FIG. 5, an array substrate in accordance with a fourth embodiment, is schematically shown. Based on the above embodiments, the main transmitting line 301 of the array substrate of the fourth embodiment includes a first main transmitting line 301a and a second main transmitting line 301b, and the synchronous transmitting line 302 of the array substrate of the fourth embodiment includes a first synchronous transmitting line 302a and a second synchronous transmitting line 302b. The first synchronous transmitting line 302a synchronously transmits the alignment signal with the first main transmitting line 301a, and the second synchronous transmitting line 302b synchronously transmits the alignment signal with the second main transmitting line 301b. The parallel data lines disposed on the substrate 40 form a number of data units 100 each which includes a first data line 101 and a second data line 102. The first end 101a and the second end 101b of the first data line 101 are respectively connected to the first main transmitting line 301a and the first synchronous transmitting line 302a. The first end 102a and the second end 102b of the second data line 102 are respectively connected to the second main transmitting line 301b and the second synchronous transmitting line 302b. The transmitting process of the alignment signal of the array substrate of the fourth embodiment is similar to that of the above mentioned embodiments, which is not given in detail here.

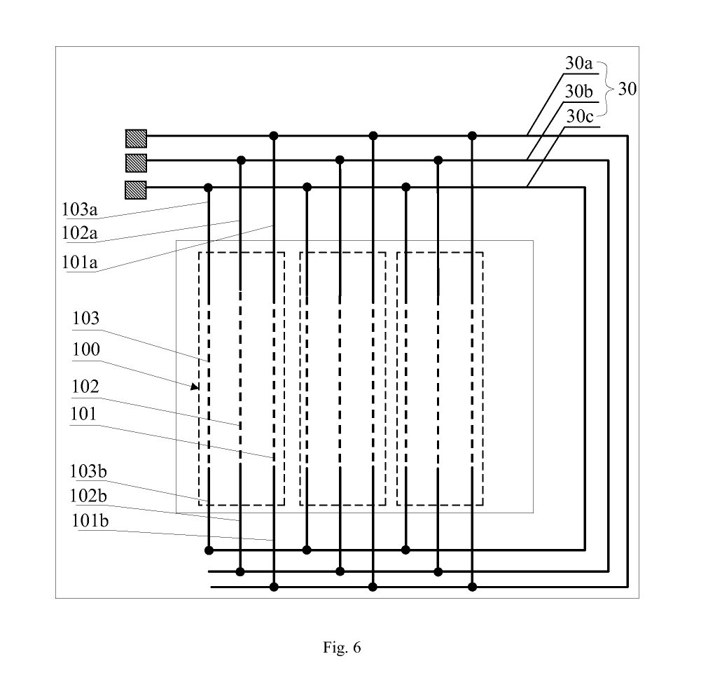

Referring to FIG. 6, an array substrate in accordance with a fifth embodiment, is schematically shown. Based on the above embodiments, the array substrate of the fifth embodiment includes three of the transmitting lines. Specifically, the transmitting line 30 of the array substrate of the fifth embodiment includes a first transmitting line 30a, a second transmitting line 30b, and a third transmitting line 30c. The parallel data lines disposed on the substrate form a number of data units 100. Each of the data unit 100 includes a first data line 101, a second data line 102, and a third data line 103. Both the first end 101a and the second end 101b of the first data line 101 are connected to the first transmitting line 30a. Both the first end 102a and the second end 102b of the second data line 102 are connected to the second transmitting line 30b. Both the first end 103a and the second end 103b of the third data line 103 are connected to the third transmitting line 30c. The transmitting process of the alignment signal of the array substrate of the fifth embodiment is similar to that of the above mentioned embodiments, which is not given in detail here. The alignment signal can be transmitted from two ends of the first data line 101, the second data line 102, or the third data line 103 to the middle portion of the corresponding data line through the first transmitting line 30a, the second transmitting line 30b, or the third transmitting line 30c. This improves the alignment consistence of the liquid crystal molecules and further improves the display effect of the liquid crystal panel.

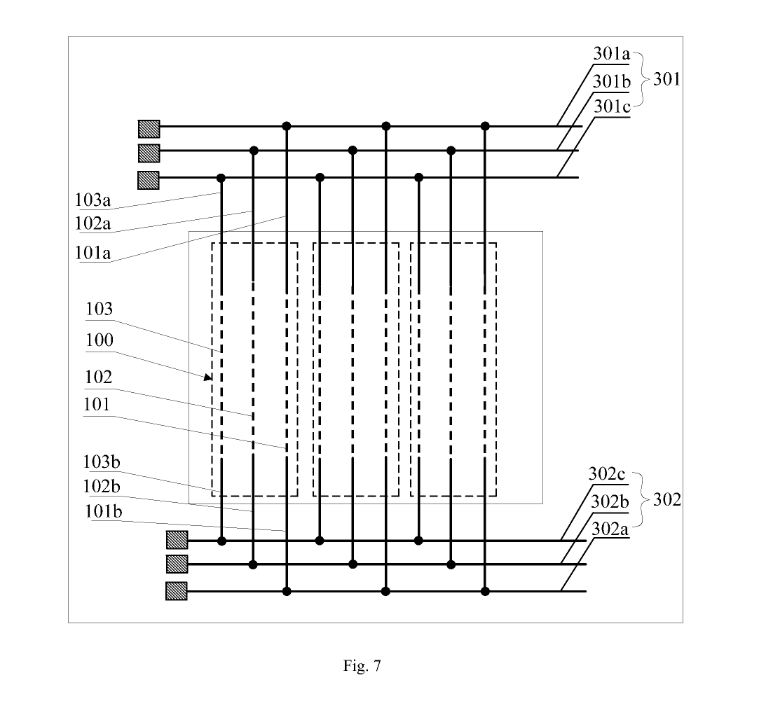

Referring to FIG. 7, an array substrate in accordance with a sixth embodiment, is schematically shown. Based on the above embodiments, the main transmitting line 301 of the embodiment includes a first main transmitting line 301a, a second transmitting line 301b, and a third transmitting line 301c. The synchronous transmitting line 302 includes a first synchronous transmitting line 302a, a second synchronous transmitting line 302b, and a third synchronous transmitting line 302c. The parallel data lines disposed on the substrate 40 form a number of data units 100. Each of the data units 100 includes a first data line 101, a second data line 102, and a third data line 103. The first end 101a and the second end 101b of the first data line 101 are respectively connected to the first main transmitting line 301a and the first synchronous transmitting line 302a. The first end 102a and the second end 102b of the second data line 102 are respectively connected to the second main transmitting line 301b and the second synchronous transmitting line 302b. The first end 103a and the second end 103b of the third data line 103 are respectively connected to the third main transmitting line 301c and the third synchronous transmitting line 302c. The transmitting process of the alignment signal of the array substrate of the fifth embodiment is similar to that of the above mentioned embodiments, which is not given in detail here.

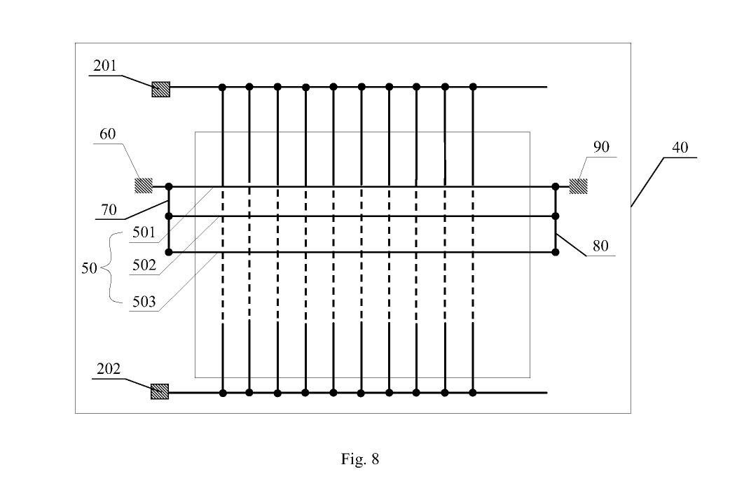

Referring to FIG. 8, an array substrate in accordance with a seventh embodiment, is shown. The array substrate of the seventh embodiment includes a gate line 50 disposed on the substrate 40, a driving module 60 for inputting a driving signal, a first conveying line 70, and a second conveying line 80. The first conveying line 70 is connected to a first terminal of the gate line 50 and the driving module 60, and the second conveying line 80 is connected to a second terminal of the gate line 50.

Specifically, the gate line 50 includes a first gate line 501, a second gate line 502, and a third gate line 503. A first terminal and a second terminal of the first gate line 501, the second gate line 502, or the third gate line 503 are respectively connected to the first conveying line 70 and the second conveying line 80. The first conveying line 70 is further connected to the driving module 60. When the is an open defect in the first gate line 501, the driving signal from the driving module 60 is transmitted to the open defect of the first gate line 501 through the first line 70 and the first terminal of the first gate line 501. Meanwhile, the driving signal from the driving module 60 is also transmitted to the open defect of the first gate line 501 through the first conveying line 70 and second gate line 502, or through the third gate line 503, the second conveying line 80, and the second terminal of the first gate line 501 in this order. Thus, the driving signal can be applied to the gate line 50 of the present disclosure normally.

Furthermore, the array substrate further includes a synchronous driving module 90 for synchronously inputting the driving signal with the driving module 60. The synchronous driving module 90 is connected to the second conveying line 80.

With synchronous driving module 90 connected to the second conveying line, if there are open defects in the first gate line 501, the second gate line 502, and the third gate line 503 respectively, the driving signal from the driving module 60 is capable of being transmitted to the part of the first gate line 501, the second gate line 502 and the third gate line 503 located between the first terminal of the first gate line 501, the second gate line 502, and the third gate line 503 to the corresponding open defects, and the driving signal from the synchronous driving module 90 is capable of being transmitted to the part of the first gate line 501, and the second gate line 502, and the third gate line 503 located between the second terminal of the first gate line 501, the second gate line 502, and the third gate line 503 and the corresponding open defects. Specifically, when there is an open defect in the gate line 50, the driving signal from the driving module 60 is transmitted to the first conveying line 70 and is further transmitted from the first terminal of the gate line 50 to the cutting point. Meanwhile, the driving signal from the synchronous driving module 90 is transmitted to the second conveying line 80 and is further transmitted from the second terminal of the gate line 50 to the cutting point.

In the present embodiment, the first terminal of the gate line 50 is connected to the first conveying line 70 and the driving module 60, and the second terminal of the gate line 50 is connected to the second conveying line 80 and the synchronous driving module 90 which synchronously inputs the driving signal with the driving module 60. Therefore, the driving signal is capable of being applied to both terminals of the gate line 50 simultaneously. This can improve the normal alignment of the liquid crystals and reduce the scrap rate of the liquid crystal panel.

The present disclosure further provides a liquid crystal panel. The liquid crystal panel includes the array substrate of any above embodiment, a color filter substrate, and liquid crystal molecules disposed between the array substrate and the color filter substrate.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. An array substrate, comprising:
a substrate;
a plurality of parallel data lines disposed on the substrate each which has a first end and a second end;
a signal inputting module for inputting an alignment signal; and
at least one transmitting line with one end thereof connected to the signal inputting module and the at least one transmitting line being further connected to the first end and the second end of each of the data lines.

2. The array substrate as claimed in claim 1, wherein the signal inputting module is disposed on the substrate and is adjacent to the first end of each of the data lines; the at least one transmitting line is connected to the signal inputting module and extends from one side of the substrate adjacent to the first end of each of the data lines to the other side of the substrate adjacent to the second end of each of the data lines.

3. The array substrate as claimed in claim 2, wherein the at least one transmitting line comprises a first transmitting line and a second transmitting line, the data lines on the substrate form a plurality of data units each which comprises a first data line and a second data line, a first end and a second end of the first data line are connected to the first transmitting line, and a first end and a second end of the second data line are connected to the second transmitting line.

4. The array substrate as claimed in claim 2, wherein the at least one transmitting line comprises a first transmitting line, a second transmitting line, and a third transmitting line; the data lines form a plurality of data units each which comprises a first data line, a second data line, and a third data line, a first end and a second end of the first data line are connected to the first transmitting line, a first end and a second end of the second data line are connected to the second transmitting line, and a first end and a second end of the third data line are connected to the third transmitting line.

5. The array substrate as claimed in claim 1, wherein the signal inputting module comprises a main inputting unit and a synchronous inputting unit for synchronously inputting the alignment signal with the main inputting unit, the at least one transmitting line comprises a main transmitting line and a synchronous transmitting line; the main inputting unit and the main transmitting line are disposed one side of the substrate adjacent to the first end of each of the data lines, one end of the main transmitting line is connected to the main inputting unit and the main transmitting line is further connected to the first end of each of the data lines; the synchronous inputting unit and the synchronous transmitting line are disposed on the other side of the substrate adjacent to the second end of each of the data lines; one end of the synchronous transmitting line is connected to the synchronous inputting unit, and the synchronous transmitting line is further connected to the second end of each of the data lines.

6. The array substrate as claimed in claim 5, wherein the main transmitting line comprises a first main transmitting line and a second main transmitting line, the synchronous transmitting line comprises a first synchronous transmitting line and a second synchronous transmitting line, the data lines form a plurality of data units each which comprises a first data line and a second data line; a first end and a second end of the first data line are respectively connected to the first main transmitting line and the first synchronous transmitting line; and a first end and a second end of the second data line are respectively connected to the second main transmitting line and the second synchronous transmitting line.

7. The array substrate as claimed in claim 5, wherein the main transmitting line comprises a first main transmitting line, a second main transmitting line, and a third main transmitting line; the synchronous transmitting line comprises a first synchronous transmitting line, a second synchronous transmitting line, and a third synchronous transmitting line; the data lines form a plurality of data units each which comprises a first data line, a second data line, and a third data line; a first end and a second end of the first data line are respectively connected to the first main transmitting line and the first synchronous transmitting line; a first end and a second end of the second data line are respectively connected to the second main transmitting line and the second synchronous transmitting line; and a first end and a second end of the third data line are respectively connected to the third main transmitting line and the third synchronous transmitting line.

8. The array substrate as claimed in claim 1 further comprising a plurality of parallel gate lines disposed on the substrate, a driving module for inputting a driving signal, a first conveying line, and a second conveying line; each of the gate lines comprises a first terminal and a second terminal; the first conveying line is connected to the first terminal of each of the gate lines and the driving module, and the second conveying line is connected to the second terminal of each of the gate lines.

9. The array substrate as claimed in claim 8 further comprising a synchronous driving module for synchronously inputting the driving signal with the driving module, the synchronous driving module is connected to the second conveying line.

10. The array substrate as claimed in claim 1, wherein the alignment signal is transmitted to each of the data lines from the first end and the second end of the corresponding data line through the at least one transmitting line.

11. A liquid crystal panel, comprising:
a color filter substrate;
an array substrate, comprising:
a substrate;
a plurality of parallel data lines disposed on the substrate each which has a first end and a second end;
a signal inputting module for inputting an alignment signal; and
at least one transmitting line with one end thereof connected to the signal inputting module and the at least one transmitting line being further connected to the first end and the second end of each of the data lines; and
and liquid crystal molecules disposed between the array substrate and the color filter substrate;

12. The liquid crystal panel as claimed in claim 11, wherein the signal inputting module is disposed on the substrate and is adjacent to the first end of each of the data lines; and the at least one transmitting line is connected to the signal inputting module and extends from one side of the substrate adjacent to the first end of each of the data lines to the other side of the substrate adjacent to the second end of each of the data lines.

13. The liquid crystal panel as claimed in claim 12, wherein the at least one transmitting line comprises a first transmitting line and a second transmitting line, the data lines form a plurality of data units each which comprises a first data line and a second data line, a first end and a second end of the first data line are connected to the first transmitting line, and a first end and a second end of the second data line are connected to the second transmitting line.

14. The liquid crystal panel as claimed in claim 12, wherein the at least one transmitting line comprises a first transmitting line, a second transmitting line, and a third transmitting line, the data lines form a plurality of data units each which comprises a first data line, a second data line, and a third data line, a first end and a second end of the first data line are connected to the first transmitting line, a first end and a second end of the second data line are connected to the second transmitting line, and a first end and a second end of the third data line are connected to the third transmitting line.

15. The liquid crystal panel as claimed in claim 11, wherein the signal inputting module comprises a main inputting unit and a synchronous inputting unit for synchronously inputting the alignment signal with the main inputting unit; the transmitting line comprises a main transmitting line and a synchronous transmitting line; the main inputting unit and the main transmitting line are disposed one side of the substrate adjacent to the first end of each of the data lines; one end of the main transmitting line is connected to the main inputting unit and the main transmitting line is further connected to the data lines; the synchronous inputting unit and the synchronous transmitting line are disposed on the other side of the substrate adjacent to the second end of each of the data lines; and one end of the synchronous transmitting line is connected to the synchronous inputting unit, and the synchronous transmitting line is further connected to the second end of each of the data lines.

16. The liquid crystal panel as claimed in claim 15, wherein the main transmitting line comprises a first main transmitting line and a second main transmitting line, the synchronous transmitting line comprises a first synchronous transmitting line and a second synchronous transmitting line, the data lines form a plurality of data units each which comprises a first data line and a second data line; a first end and a second end of the first data line are respectively connected to the first main transmitting line and the first synchronous transmitting line; a first end and a second end of the second data line are respectively connected to the second main transmitting line and the second synchronous transmitting line.

17. The liquid crystal panel as claimed in claim 15, wherein the main transmitting line comprises a first main transmitting line, a second main transmitting line, and a third transmitting line; the synchronous transmitting line comprises a first synchronous transmitting line, a second synchronous transmitting line, and a third synchronous transmitting line; the data lines form a plurality of data units each which comprises a first data line, a second data line, and a third data line; a first end and a second end of the first data line are respectively connected to the first main transmitting line and the first synchronous transmitting line; a first end and a second end of the second data line are respectively connected to the second main transmitting line and the second synchronous transmitting line; and a first end and a second end of the third data line are respectively connected to the third main transmitting line and the third synchronous transmitting line.

18. The liquid crystal panel as claimed in claim 11 further comprising a plurality of parallel gate lines disposed on the substrate, a driving module for inputting a driving signal, a first conveying line, and a second conveying line; each of the gate lines comprises a first terminal and a second terminal; the first conveying line is connected to the first terminal of each of the gate lines and the driving module, and the second conveying line is connected to the second terminal of each of the gate lines.

19. The liquid crystal panel as claimed in claim 18 further comprising a synchronous driving module for synchronously inputting the driving signal with the driving module, the synchronous driving module is connected to the second conveying line.

20. The liquid crystal panel as claimed in claim 11, wherein the alignment signal is transmitted from the first end and the second end of each of the data lines to the corresponding data line through the at least one transmitting line.
